(19) United States
(12) Patent Application Publication
(10) Pub. No.: US 2007/0297816 A1
(43) Pub. Date: Dec. 27, 2007

(54) Image forming apparatus and control method thereof

(75) Inventor: Katsunori Teshima, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/785,362

(22) Filed: Apr. 17, 2007

(30) Foreign Application Priority Data
Jun. 26, 2006 (JP) JP2006-174907

(51) Int. Cl. G03G 15/00; G03G 13/00

(52) U.S. Cl. 399/16

(57) ABSTRACT

In a control method of an image forming apparatus having an image forming section which forms an image on a sheet, and an ejecting section which ejects, as a print set unit, a plurality print sets of sheets on each of which an image has been formed by the image forming section, the control method includes the steps of: detecting an impact applied to the apparatus from an outside thereof, with an impact detector while the image forming section performs an image forming operation; identifying a print set including a sheet on which an image of a page has been formed, to which the image forming operation has been performed when the impact detector detects the impact; and ejecting the identified print set which is distinguished from other print sets.

This application is based on Japanese Patent Application No. 2006-174907 filed on Jun. 26, 2006, which is hereby incorporated by reference.

### BACKGROUND OF THE INVENTION

The present invention relates to a control method of an image forming apparatus which ejects sheets carrying images by a print set unit, and to an image forming apparatus incorporating the control method.

In image forming apparatuses, such as copy machines, printers and printing machines, there are cases in which documents formed of plural pages are outputted as plural print sets, or image data formed of plural pages are outputted as plural print sets. Specifically, a large number of printed sheets are continuously outputted by the printing machines, therefore high printing productivity has been demanded in printing business world.

When such plural print sets of sheets are outputted by the image forming apparatus, if any impact is applied to the apparatus during the printing operation, defective images are likely to be printed on the individual sheets.

Therefore, a technology to terminate image formation when any fault happens is proposed. On the technology shown in Unexamined Japanese Patent Application Publication No. 09-62151, by detecting the faults which affect image formation, such as sheet feeding jams or errors of video data, the recording sheet are temporarily interrupted. Timing for printing procedure is then adjusted, and image formation is restarted from the error sheet. Further, according to the technology shown in Unexamined Japanese Patent Application Publication No. 09-62151, no defective images are formed on the recording sheets, which produces printed matter of high reliability.

However, like the technology shown in Unexamined Japanese Patent Application Publication No. 09-62151, if sheet conveyance is temporarily terminated when a fault happens, productivity of printed matter is reduced, which is a major problem in the printing business world which demands high productivity.

### SUMMARY OF THE INVENTION

One aspect of the present invention is a control method of an image forming apparatus having an image forming section which forms an image on a sheet, and an ejecting section which ejects, as a print set unit, a plurality print sets of sheets on each of which an image has been formed by the image forming section, the control method including the steps of: detecting an impact applied to the apparatus from an outside thereof, with an impact detector while the image forming section performs an image forming operation; identifying a print set including a sheet on which an image of a page has been formed, to which the image forming operation has been performed when the impact detector detects the impact; and ejecting the identified print set which is distinguished from other print sets.

Another aspect of the present invention is an image forming apparatus including: an image forming section which forms an image on a sheet; an impact detector which detects an impact applied to the apparatus from an outside thereof; an ejecting section which ejects sheets, as a print set unit, on each of which an image has been formed with the image forming section; and a controller which controls the ejecting section so that when the impact detector detects the impact while an image forming operation is performed, the ejecting section distinguishes a print set including a sheet on which an image of a page has been formed, to which the image forming operation has been performed when the impact detector detects the impact, and ejects the print set which is distinguished from other print sets.

Still another aspect of the present invention is an image forming apparatus including: an image forming section which forms an image on a sheet; an impact detector which detects an impact applied to the apparatus from an outside thereof; an ejecting section which ejects sheets, as a print set unit, on each of which an image has been formed with the image forming section; and a controller which controls the ejecting section so that when the impact detector detects the impact while an image forming operation is performed, the ejecting section identifies a print set to which a prescribed operation with relation to the image forming operation has been performed, and ejects the identified print set which is distinguished from other print sets.

### BRIEF DESCRIPTION OF THE DRAWINGS

FIG. 1 is a front view of an image forming apparatus relating to the present invention.

FIG. 2 is a block diagram of a control structure of the image forming apparatus.

FIG. 3 is a flowchart of the operation for outputting the plural print sets.

FIG. 4 details a condition under which an identified print set is ejected onto sheet ejecting tray B1.

FIG. 5 is a flowchart of the operation of a re-outputting mode.

FIG. 6 shows an operation display section on which the image of an identified page number is displayed.

### DETAILED DESCRIPTION OF THE PREFERRED EMBODIMENT

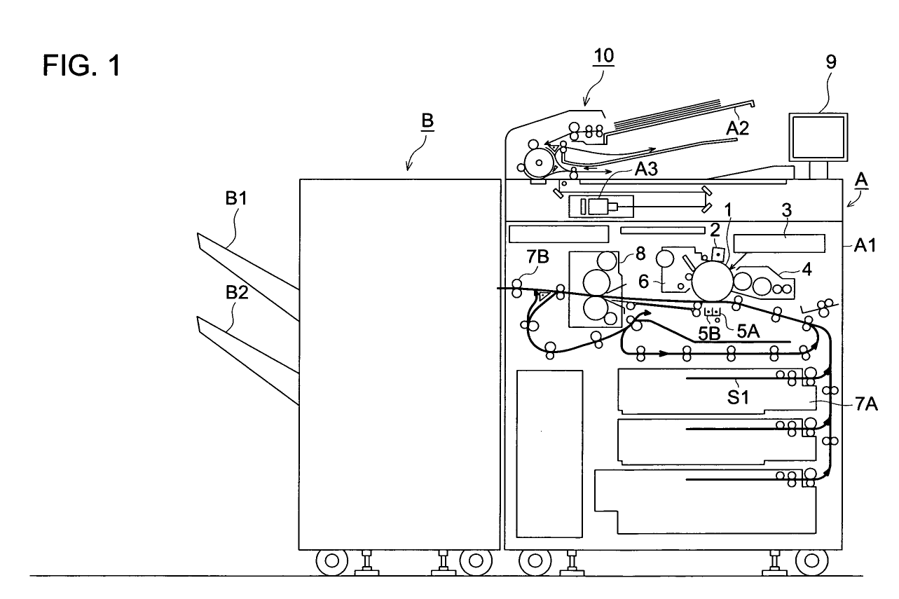

FIG. 1 is a front view of the image forming apparatus relating to the present invention.

Image forming apparatus 10 is structured of main body section A and finisher section B.

Main body section A includes image forming section A1 which serves as an image forming means, document conveying section A2, and image reading section A3.

Around drum-type photoreceptor 1 of image forming section A1, charging unit 2, imagewise exposure unit 3, developing section 4, transfer unit 5A, separation unit 5B, and cleaning unit 6 are mounted, whereby various processes, such as electrical charge, exposure, development and transfer are conducted, to form a toner image on sheet S1. Sheet S1, carrying the transferred toner image passes through fixing unit 8, whereby the toner image is fixed. After fixing, sheet S1 is ejected to the outside of main body section A by paired sheet ejecting rollers 7B.

Further, large sized operation display section 9 is installed in main body section A, whereby the operator can set printing conditions to execute printing by image forming apparatus 10.

In finisher section B, finishing operations, such as book-binding and stapling, are conducted on sheets S1 which are sent from main body section A. Further, finisher section B can output stacked sheets S1 as a print set unit, that is, finisher section B temporarily stacks sheets S1 on an internal tray, and conducts the finishing operation onto stacked sheets S1 according to needs, after which the conveyance route is changed, and sheets S1 as a print set unit is ejected onto sheet ejecting tray B1 or B2. In this case, the number of the print sets to be ejected from finisher section B is set by operation display section 9. In addition, one print set includes plural sheets. Here, a print set (also referred to as a copy set) represents a part unit in one print job, and includes plural pages of print sheets. That is, one print job is constituted of plural print sets.

In addition, image forming apparatus 10 of the present embodiment forms monochromatic images by an electro-photographic method, however the image forming apparatus relating to the present invention is not limited to the present embodiments. For example, various apparatuses can be employed which form the image on a sheet, such as an image forming apparatus employing an inkjet printing method and a color image forming apparatus.

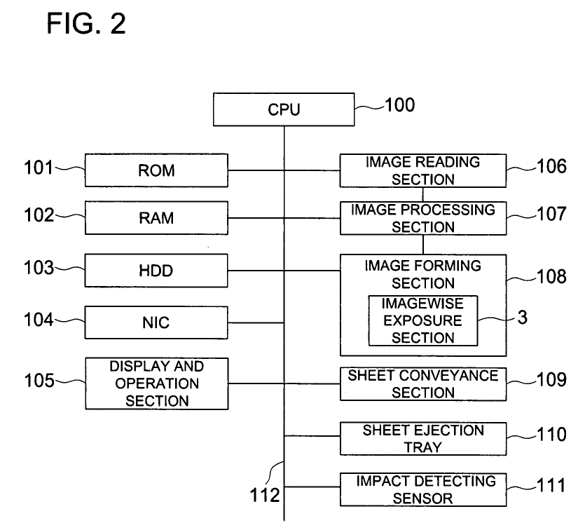

FIG. 2 is a block diagram of a control structure of the image forming apparatus, which shows typical control structures.

CPU 100, serving as a control means, controls total operations of image forming apparatus 10, and CPU 100 is connected to ROM (Read Only Memory) 101 and RAM (Random Access Memory) 102, via system bus 112. CPU 100 reads out the various control programs stored in ROM 101 and develops them on RAM 102, whereby the operation of each section is controlled. Further, CPU 100 executes various processes based on the programs developed in RAM 102, and stores processed results in RAM 102, and further displays the processed results on operation display section 105. Yet further, CPU 100 controls to store the processed results stored in RAM 102 on predetermined storing sections.

ROM 101, previously stored the programs and data, is structured of magnetic recording media, optical recording media, or semi-conductive memory.

RAM 102 forms a working area to temporarily store the data processed by the various control programs which are executed by CPU 100.

HDD (Hard Disk Drive) 103, serving as a memory means, functions to memorize the image data outputted onto image forming apparatus 10. HDD 103 includes plural metal disks on which magnetic materials are coated or evaporated, which are superposed at a constant interval, whereby the disks are rotated by a motor at high speed, and the memorized data is read by a magnetic head which is controlled to be adjacent to the disks.

NIC (Network Interface Card) 104 interfaces system bus 112 and external networks, such as a LAN, to allow image forming apparatus 10 to communicate to external terminals through NIC 104.

Operation display section 105 works to set various settings, via which an operator sets specific printing operations. Further, operation display section 105 displays various relevant information, such as network setting information.

Image reading section 106 reads the document image by an optical method, and changes it to digital signal as an image data. The created image data is processed by image processing section 107, and is outputted to image forming section 108.

Image forming section 108, serving as an image forming means, forms the image on recording sheet S1, based on the image data processed by image processing section 107. Image forming section 108 includes imagewise exposure unit 3, serving as a reading means, and imagewise exposure unit 3 writes image information on photoreceptor 1.

Sheet conveyance section 109, serving as a sheet ejecting means, conveys recording sheets S1 carrying the formed image to any one of sheet ejecting tray B1 or B2. Since sheet conveyance section 109 ejects recording sheets S1 as a print set unit, recording sheets S1 are stacked upstream of sheet ejecting tray B1 or B2, with respect to the recording sheet conveyance direction, and when a targeted number of recording sheets S1 included in one print set are stacked, the print set is ejected onto sheet ejecting tray B1 or B2 as a print set unit.

Impact detector 111, serving as the impact detecting means, detects accidental impacts to image forming apparatus 10. As a method for detecting the impact, a piezo element, for example, is used. When the piezo element detects an impact, the piezo element generates an electrical current, which is detected as the impact, or alternatively, the impact can be detected by an acceleration sensor.

While image forming apparatus 10 outputs plural print sets, if image forming apparatus 10 receive the impact, a blurred image may be formed on sheet S1. To overcome this problem, operation of image forming apparatus 10 can be interrupted, but thereby, productivity of the printed matter is reduced.

To overcome such reduced image formation productivity, in the present embodiment, even when the impact occurs to blur the image during image formation operation, the outputted printed matter is selected as a print set unit and ejected, but image forming apparatus 10 is not interrupted, which will now be detailed.

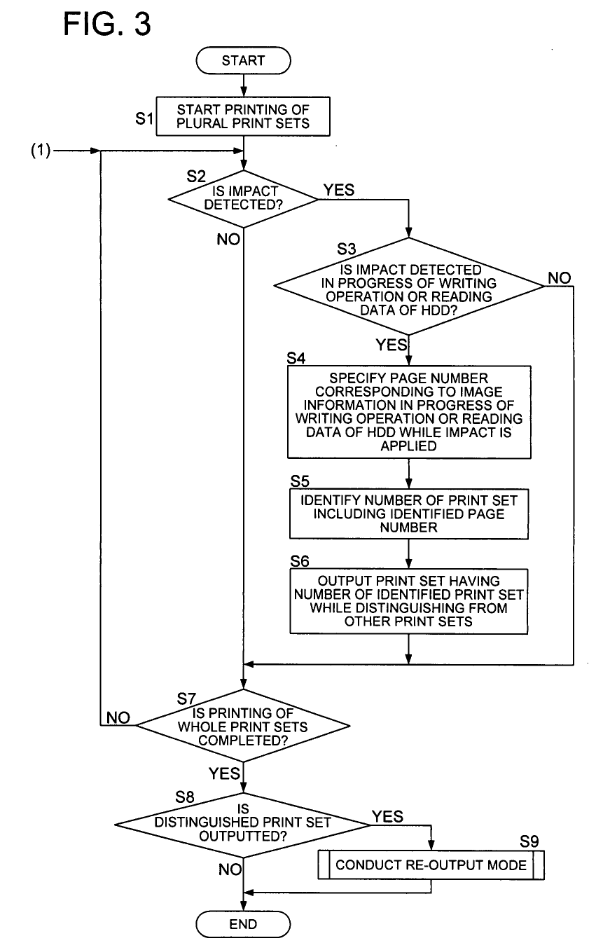

FIG. 3 is a flowchart of the operation for outputting plural print sets of sheets S1.

Firstly, based on the printing conditions entered by the operator, image forming apparatus 10 starts printing of the plural print sets (step S1). While printing, impact detector 111 checks whether an impact occurred to image forming apparatus 10 or not (step S2). Since an impact entering from the outside adversely affects image formation, such impact is detected by impact detector 111, detailed in FIG. 2.

When impact detector 111 detects an impact, CPU 100 checks whether the impact occurred while an electrostatic latent image was being formed on photoreceptor 1 via imagewise exposure unit 3 of image forming section A1, that is, whether the impact was detected while exposure unit 3 was writing the image, or if the impact occurred while the data stored in HDD 103 was being read out (step S3). Because such impact adversely affects the operation, defective images may be printed and outputted from image forming apparatus 10. In the present embodiment, among the various image forming operations, the operations, such as an image writing operation onto photoreceptor 1 by imagewise exposure unit 3, and data reading operation from HDD 103, are previously determined as the selected operations to be monitored. In the case of the image forming apparatus by the inkjet printing method, the operation of ink ejection onto the recording sheet will be the selected operation.

Accordingly, when an impact is detected during the image writing operation, the specific page number of the recording sheet, on which the image was being formed by said operation, is identified (step S4). For example, the image data which is written by imagewise exposure unit 3, or the image data which is read out from HDD 103, is counted by a counter for each page, therefore the page number can be identified by a count number, counted just when the impact occurred. The page number is identified by a predetermined program executed by CPU 100.

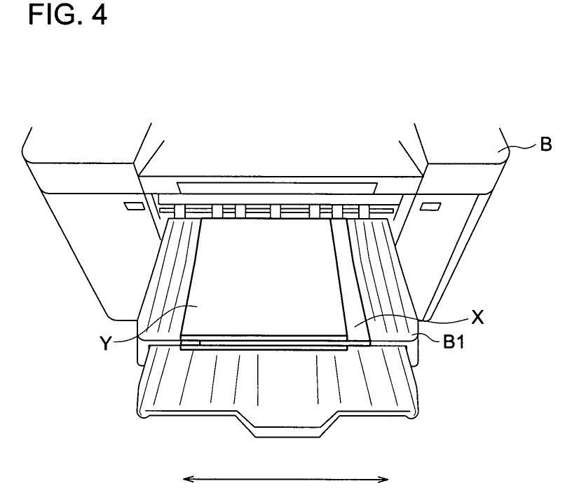

After the page number is identified, the number (being a print set number) of the print set which includes the identified page number is identified (step S5), and that print set carrying the identified print set number is separated from other print sets and is outputted (ejected) from image forming apparatus 10 (step S6). The affected print set carrying the identified print set number may include the sheets carrying the defective image, because the image forming operation (such as the image writing operation) is adversely affected by the impact on image forming apparatus 10. Since the affected print set carrying the identified print set number is separated from the normal print sets and is outputted from image forming apparatus 10, the operator can easily recognize the print set carrying the identified print set number. Concerning the method of separately outputting the print set carrying the identified print set number from the normal print sets, for example, if image forming apparatus 10 incorporates plural ejecting trays B1 and B2 as shown in FIG. 1, an ejecting route (which is not illustrated) of finisher section B is switched so that the print set carrying the identified print set number can be separated and ejected onto a predetermined tray. Further as shown in FIG. 4, if sheet ejecting tray B1 can be shifted left or right, when print set X carrying the identified print set number is ejected, sheet ejecting tray B1 is shifted left for example. Print set X carrying the specified print set number is outputted to a position on tray B1 which is shifted from the position of other print sets Y, which is easily noted by the operator. Still further, in the case of conducting the stapling operation at finisher section B, it is possible to output print set X, carrying the identified print set number, while no stapling is conducted on print set X.

On the flowchart in FIG. 3, after the print set carrying the specified print set number is distinguished and outputted, CPU 110 checks whether a whole number of print sets have been printed or not (step S7), if not (No in step S7), operations steps S2-S6 are repeated. If the whole print sets have been printed (Yes in step S7), CPU 100 checks whether the normal print sets, in which all images have been correctly printed, and whether the distinguished print set exists or not (step S8). The operational history of image forming apparatus 10 is monitored for the check. If no distinguished print set exists (No in step S8), the operation is completed, but if the distinguished print set exists, the re-outputting mode is executed (step S9). Additionally, the re-outputting mode is used for outputting additional prints for the distinguished print set, because the print set, including the recording sheets carrying the defective image, has been ejected.

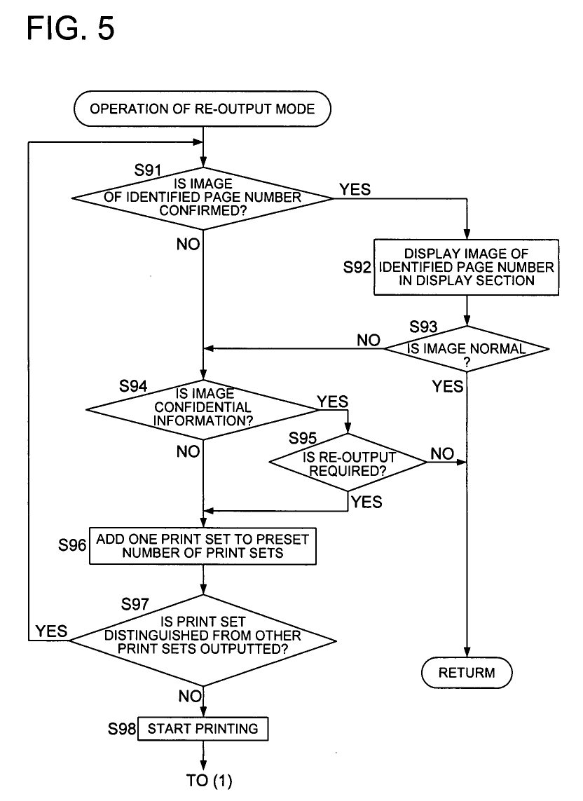

FIG. 5 is a flowchart of the operation of the re-outputting mode.

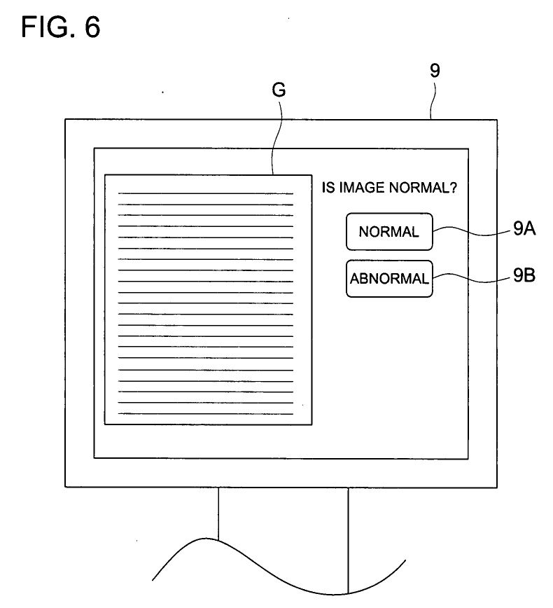

On the flowchart in FIG. 3, CPU 100 determines whether the image corresponding to the page number identified in step S5 is to be checked or not (step S91). If the image is determined not to be checked (No in step S91), the image corresponding to the page number identified in step S5 is immediately determined as the defective image, whereby the operation shifts to step S94 and its subsequent steps, to output the additional print set. On the other hand, if the image is determined to be checked (Yes in step S91), the image corresponding to the page number identified in step S5 is displayed on operation display section 9 (step S92), and the displayed image is checked by the operator whether it is normal or not (step S93). An example of operation display section 9, which displays the image corresponding to the identified page number, is shown in FIG. 6. In order to check small characters, image G can be magnified to be a larger size on operation display section 9. By displaying an enlarged image, the operator can easily check whether image G is normal or not. If the operator checks image G on operation display section 9 and judges it as normal, the operator pushes normal button 9A, whereby the additional print set is not outputted. On the other hand, if the operator judges image G as abnormal, the operator pushes abnormal button 9B, whereby the operation shifts to step S94 and its subsequent steps, to output the additional print set. In addition, in step S92, image G is displayed on operation display section 9, and image G is checked by the operator whether it is normal or not. Alternatively, it is also possible for the operator to check the images on the recording sheets ejected onto sheet ejecting tray B1, and to input a checked result on operation display section 9.

Next, the operator checks whether the image is confidential information or not (step S94). If it is confidential information, in order to control the number of the outputted print sets, it is not recommended for the operator to output additional print sets without careful consideration, from the view point of leakage of secret. If it is not confidential information (No in step S94), the operator adds one print set to the preset number of print sets (step S96). On the other hand, if it is confidential information (Yes in step S94), the operator checks whether the print set is to be re-outputted or not (step S95), and if the operator judges to re-output it, even though it is confidential information, one print set is added to the set number of print sets. (step S96).

Next, CPU 100 checks whether any other distinguished and outputted print set exists, (step S97), and if it exists, steps S91-S96 are repeated. However if not, one print set is added to be printed (step S98), and the procedure advances to step S2 in FIG. 3, and the sequence of operations is then repeated.

As described above, based on the present embodiment, while plural print sets are printed, though any accident occurs, such as an impact, which may cause faulty operation relating to the image formation, plural print sets can be printed out, but image formation is not interrupted. Further, any print set which includes a defective image is distinguished from other print sets and is outputted, whereby, printing productivity is not decreased, and the operator can easily recognize the distinguished print set. Yet further, based on the number of faulty print sets, since the additional number can be outputted while the operator evaluates the image, it is possible for the operator to produce print sets having the normal images, of the required number.

The above descriptions of the present embodiment is not limited to this embodiment. These detailed structures and operations of the image forming apparatus relating to the present embodiment can be changed as appropriate within the scope of this invention as long as it does not deviate from the contents of the present invention.

According to the control method of the image forming apparatus relating to the present invention, as well as to the image forming apparatus controlled by the same control method, productivity of printed matter is controlled not to be reduced, and the operator can easily recognize any print set in which a recording sheet carrying a defective image is included.

What is claimed is:

1. A control method of an image forming apparatus having an image forming section which forms an image on a sheet, and an ejecting section which ejects, as a print set unit, a plurality print sets of sheets on each of which an image has been formed by the image forming section, the control method comprising the steps of:
(a) detecting an impact applied to the apparatus from an outside thereof, with an impact detector while the image forming section performs an image forming operation;
(b) identifying a print set including a sheet on which an image of a page has been formed, to which the image forming operation has been performed when the impact detector detects the impact; and
(c) ejecting the identified print set which is distinguished from other print sets.

2. The method of claim 1, further comprising the step of ejecting additionally at least one print set of sheets on which images have been formed.

3. The method of claim 2, wherein the step of additionally ejecting includes ejecting an additional print set of sheets on which images have been formed, on the basis of the number of identified print sets.

4. The method of claim 2, further comprising the step of judging whether or not the step of additionally ejecting is carried out, on the basis of an input from an operation section.

5. The method of claim 1, further comprising the step of displaying the image of the page to which the image forming operation is performed when the impact detector detects the impact, on a display section.

6. The method of claim 1, wherein the apparatus comprises a writing section which writes image information on an image carrier or a recording medium, and the operation with relation to the image formation represents an operation in which the writing section writes the image information on the image carrier or the recording medium.

7. The method of claim 1, wherein the apparatus comprises a memory section which stores image information, and the operation with relation to the image formation represents an operation which reads the image information stored in the memory section.

8. An image forming apparatus comprising:
(a) an image forming section which forms an image on a sheet;
(b) an impact detector which detects an impact applied to the apparatus from an outside thereof;
(c) an ejecting section which ejects sheets, as a print set unit, on each of which an image has been formed with the image forming section; and
(d) a controller which controls the ejecting section so that when the impact detector detects the impact while an image forming operation is performed, the ejecting section distinguishes a print set including a sheet on which an image of a page has been formed, to which the image forming operation has been performed when the impact detector detects the impact, and ejects the print set which is distinguished from other print sets.

9. The image forming apparatus of claim 8, wherein the controller controls the ejection section to eject additionally at least one print set of sheets on which images have been formed.

10. The image forming apparatus of claim 9, wherein the controller controls the ejection section to eject additional print set of sheets on which the images have been formed on the basis of the number of print sets which are distinguished from the other print sets.

11. The image forming apparatus of claim 9, wherein the controller judges whether or not the ejection section ejects the additional print set, on the basis of an input from an operation section.

12. The image forming apparatus of claim 8, further comprising a display section which displays the image of the page to which the image forming operation has been performed, when the impact detector detects the impact.

13. The image forming apparatus of claim 8, further comprising a writing section which writes image information onto an image carrier or a recording medium, wherein the operation with relation to the image formation is an operation in which the writing section writes the image information onto the image carrier or the recording medium.

14. The image forming apparatus of claim 8, further comprising a memory section which stores image information, wherein the operation with relation to the image formation is an operation which reads the image information stored in the memory section.

15. An image forming apparatus comprising:
(a) an image forming section which forms an image on a sheet;
(b) an impact detector which detects an impact applied to the apparatus from an outside thereof;
(c) an ejecting section which ejects sheets, as a print set unit, on each of which an image has been formed with the image forming section; and
(d) a controller which controls the ejecting section so that when the impact detector detects the impact while an image forming operation is performed, the ejecting section identifies a print set to which a prescribed operation with relation to the image forming operation has been performed, and ejects the identified print set which is distinguished from other print sets.

16. The image forming apparatus of claim 15, wherein the controller controls the ejection section to eject additionally at least one print set of sheets on which images have been formed.

17. The image forming apparatus of claim 15, further comprising a writing section which writes image information onto an image carrier or a recording medium, wherein the operation in relation to the image formation is an operation in which the writing section writes the image information onto the image carrier or the recording medium.

18. The image forming apparatus of claim 15, further comprising a memory section which stores image information, wherein the operation with relation to the image formation is an operation which reads the image information stored in the memory section.
